(19) United States
(12) Patent Application Publication
(10) Pub. No.: US 2014/0282621 A1
(43) Pub. Date: Sep. 18, 2014

(54) DIGITAL MEDIA METRICS DATA MANAGEMENT APPARATUS AND METHOD

(71) Applicant: TELEMETRY LIMITED, London (GB)

(72) Inventors: Geo CARNCROSS, Ealing (GB); Beau CHESLUK, London (GB); Anthony RUSHTON, West Byfleet (GB); Russell IRWIN, London (GB); Daniel MORSE, London (GB); Paul FREEMAN, London (GB); Nathan SIVYER, London (GB); Mindaugas RASIUKEVICIUS, Wembley (GB); John CARTER, London (GB)

(73) Assignee: TELEMETRY LIMITED, London (GB)

(21) Appl. No.: 14/038,529

(22) Filed: Sep. 26, 2013

Related U.S. Application Data
(63) Continuation of application No. 13/838,036, filed on Mar. 15, 2013.

(51) Int. Cl. G06F 9/54

(52) U.S. Cl. CPC G06F 9/542
USPC 719/318

(57) ABSTRACT

A metrics data management apparatus and method is disclosed comprising receiving event data of a series of events from a source, processing the event data into a format identifying the source and a session of each event; populating the event data relevant to a series of connected events of a single session into an event repository, and a session build module to determining a complete session from event data relevant to a series of connected events of a single session by a predetermined event.

### TECHNICAL FIELD

This invention relates to apparatus and method for management of digital media metrics data, and more specifically, for management and analysis of digital media metrics data received from a plurality of sources.

### BACKGROUND

As a result of the increase in the number of computing devices available to users, the proportion of media viewed and/or heard by the public through an internet connection has increased. It is expected in the coming years that this proportion will increase further so that a significant proportion of the media viewed and/or heard by users will be viewed on electronic devices such as laptops, netbooks, tablets and mobile phones through interfaces such as web browsers.

The introduction of personal video recorders (PVRs), digital set-top boxes and digital radios in recent years has decreased the effectiveness of advertisements within such traditional areas as television and/or radio “ad-breaks” The placement of advertisements to capture the emerging mechanisms for viewing and listening to media has therefore been a subject of interest within the advertising industry in recent years.

In particular, digital video and/or audio advertising is increasingly used. An advertiser or advertising agency will create media, typically in the form of an advertisement, i.e. a digital video and/or digital audio. The advertisement is distributed by a publisher who delivers the digital video and/or audio content to positions within web pages to be viewed and/or heard by a user. It is common for an advertiser to pay the publisher per instance of the digital video and/or audio content delivered, in other terms per “impression” or “placement”. However, in order for the advertiser to be confident that they are receiving value for money it is important that the digital video and/or audio content is provided to the viewer and/or listener in a way that enables the viewer and/or listener to view and/or listen to the media, for example in the form of visible and/or audible digital video and/or audio content.

In order to ascertain the effectiveness, and therefore the value, of an advertising campaign directed to digital media obtained through an internet connection, a number of metrics are useful to track. Metric data may include an indication whether played media such as an advertisement is, for example: displayed on the screen; clicked on by a user during play of the advertisement; paused or stopped by a user before completion of the advertisement; fully played back by the user device; repeatedly played back by the user; etc, Tracking metric data across the internet and then analyzing the tracked metric data may be extremely memory and processing intensive as the number of user devices playing the media advertisement over a specific period of time, for example 24 hours, may be vast and produce large data sets. Accordingly, the costs in processing time and processing power in the management of metrics data may become substantial.

There is a need for a digital media metrics data management apparatus and method that addresses or at least alleviates the above issues.

### SUMMARY

An aspect of the invention is a metrics data management apparatus comprising an ingestion module to receive event data of a series of events from a source, and to process the event data into a format identifying the source and a session of each event; and an event repository to populate the event data relevant to a series of connected events of a session.

In an embodiment the ingestion module receives event data from a plurality of sources.

In an embodiment the session starts at the moment a request is received at the source to access a digital media.

In an embodiment the ingestion module is arranged to process the event data into a format identifying the time order of each event data within a session.

In an embodiment the ingestion module is arranged to process the event data into a format identifying the time order of each session.

In an embodiment the ingestion module is arranged to process the event data into a format comprising a time stamp.

In an embodiment the ingestion module is arranged to process the event data into a format comprising an error correction code (ECC).

In an embodiment the ingestion module is arranged to process the event data into a format comprising a data length.

In an embodiment the source is a user device.

An aspect of the invention is a metrics data management apparatus comprising an event repository to populate event data relevant to a series of connected events of a session, wherein the event data is of a series of events from a source in a format identifying the source and a session of each event; and a session build module to determine a complete session from event data relevant to a series of connected events of a single session by a predetermined event.

In an embodiment the session ends at a predetermined event. The predetermined event may be a period of time. The predetermined event may be defined by predefined parameters.

In an embodiment the session may have a current status before the predetermined event and an expired status after the predetermined event. The session build module may be arranged to transmit the session with an expired status for further processing at a metrics data analyzer processer and the session has a confirmed status after the transmission and further processing of the expired session. The session build module may be arranged to remove the expired status session and confirmed status sessions from the session build module and corresponding event data from the event repository after transmission and further processing of the expired session.

An aspect of the invention is a metrics data management apparatus comprising an ingestion module to receive event data of a series of events from a source, and to process the event data into a format identifying the source and a session of each event; an event repository to populate the event data relevant to a series of connected events of a session; and a session build module to determine a complete session from event data relevant to a series of connected events of a session by a predetermined event.

An embodiment further comprises a metrics data analyzer comprising a metrics report generator for generating a report based on the complete session,

An aspect of the invention is a metrics data management method of comprises receiving event data of a series of events from a source; processing the event data into a format identifying the source and a session of each event; populating the event data relevant to a series of connected events of a session into an event repository; and determining a complete session from event data relevant to a series of connected events of a single session by a predetermined event.

An embodiment further comprises generating a report based on the complete session.

### BRIEF DESCRIPTION OF THE DRAWINGS

For better understanding of the invention and to show how the same may be carried into effect, reference will now be made, by way of example only, to the accompanying figures, in which:

FIG. 1 illustrates schematically an overview of a system network for web media distribution and digital media metrics data management apparatus in accordance with an embodiment of the invention;

FIG. 2 illustrates schematically a diagram of data acquisition from web media in accordance with an embodiment of the invention;

FIG. 3 illustrates schematically a diagram of a user device in accordance with an embodiment of the invention;

FIG. 4 illustrates schematically a block diagram of a metrics data manager and analyzer in accordance with an embodiment of the invention;

FIG. 5 illustrates schematically a block diagram of event data flow from a plurality of metrics media servers to an ingestion module of a metrics data manager in accordance with an embodiment of the invention;

FIG. 6 illustrates schematically a data format for event data in accordance with an embodiment of the invention;

FIG. 7 illustrates schematically a block diagram of a metrics data manager in accordance with an embodiment of the invention;

FIG. 8 illustrates schematically a block diagram of a metrics data analyzer in accordance with an embodiment of the invention;

FIG. 9 is a flow chart of a method in accordance with an embodiment of the invention;

FIG. 10 is a state diagram of status of sessions in accordance with an embodiment of the invention; and

FIG. 11 is a flow chart of updating session status according to time in accordance with an embodiment of the invention.

### DETAILED DESCRIPTION

References will now be made in detail to the embodiments of the invention, examples of which are illustrated in the accompanying figures. In the following detailed description, numerous specific details are set forth in order to provide a thorough understanding of the invention. However, it will be apparent to one of ordinary skill in the art that the invention may be practiced without these specific details.

FIG. 1 illustrates schematically an overview 10 of a system network for web media distribution and paths of digital data traffic flow, as shown by the single ended arrows between components of a digital media metrics data management apparatus for delivery measurement, recordation and reporting of media metrics in accordance with an embodiment of the invention. As shown in FIG. 1, the network may provide communications via a wired or wireless network, such as for example the Internet 12, local area network (LAN), direct communication between components, cellular networks, or the like, as shown by dashed double ended arrows. The network comprises a user terminal or device 14 supporting a web browser and a media or ad player 16. A metrics media server 20 or ad server runs like a plug-in for the media player 16 on the user device 14. With metrics data manager and analyzer 22, the metrics media server tracks and reports with metrics report 24 on the media session or ad session played on the media player 16 of the user device 14. Parties that may be interested in the metrics report 24 include the advertiser or media promoter 18 that typically buys some advertisement volume of a publisher or publisher media server 30 and possibly one or more network publishers 32 as well. The metrics media server 20 tracks advertising metrics that may be based on advertising impressions, click-throughs for the placement, campaign, creative, etc., from the context of the advertiser 18 and the publisher 32. The advertiser or media promoter 18 places an insertion order with the network publisher 32, and may receive an invoice from the network publisher 32. The network publisher 32 sends a request to create and start a session with the metrics media server 20, The metrics media server 20 sends media or ad player configuration data to the user device 14 media player 16 and receives media or ad tracking metrics data from the user device 14 media player 16 for the advertiser. The publisher media server 30 may also receive some form of data from the user device 14 media player 16 for tracking purposes. The user terminal or user device 14 may take the form of any electronic device which is capable of running a web browser. In some examples, instead of a web browser, other types of interface through which web-based media may be obtained and made available may be used. In some examples, the user terminal 14 may be a desktop computer or personal computer (PC).

In some examples, the user terminal 14 may be a portable or mobile device with a wired or wireless data connection. In some examples, the user terminal 14 may be a tablet computing device, a netbook, a laptop or a mobile phone capable of running a web browser. In examples where a web browser is used, the web browser may, for example, comprise one of the following web browsers; Google Chrome™, Mozilla Firefox™, Internet Explorer™, Safari™, or the like. This list is not intended to be exhaustive. The user terminal 14 may comprise audio output means, or may be associated with audio output means, or both. In use, the web browser may be operated to access web pages. Some web pages may be designed to enable media to be played. In some examples, the media may be in the form of a video with associated audio or in the form of standalone video or audio content. In some examples the media may in the form of pre-roll video or pre-roll audio that is delivered before further content is delivered, in some examples, the media may take the form of digital audio or rich media. In some examples, the media may be interactive. In some examples media is presented to or played on web pages using one or more media players or netstreams.

In an embodiment the metric data may include an indication of particular events occurring on the user device 14 during the session or time the media is made available to play on the user device. A user device is the source of the metrics data or event data, wherein the source is an implementation of the media or ad tracking measurement. A session is created, for example, whenever the publisher has requested a session request from the metrics media server 20. For example, the moment in time the media is made available on the user device for the user device to play, a metric tracking session has already been created and able to associate tracked metrics event data with the session. A metric tracking session ends after a predetermined time or event. Each session has at least a start event and an end of session event, with additional events tracked between. Signals from the digital player are programmed to return data events in order, but may refer to events out of order, for example a click followed by a pause caused by the click, and the like, For example, the types of metric events that may be useful in tracking may be whether the media that is played is: displayed on the screen; how long the media is displayed on the screen before it is played; clicked on by a user during play of the advertisement; paused or stopped by a user before completion of the advertisement; fully played back by the user device; repeatedly played back by the user; etc. Upon the occurrence of each metric event a “hitline” or event data is generated and delivered to the metrics data manager and analyzer 22 via the metrics media server 20.

The media, for example an advertisement, may be distributed through a number of different servers before it is delivered to the web browser of the user device 14. The distribution of media, and particularly video media such as advertisements, can be considered a marketplace of selling and re-selling of media publications. In some examples of this marketplace, the audibility of media presented to a user can be subject to a number of audio controls, this may include for example, without limitation: creative-embedded audio controls managed by an ad unit/player; player-embedded audio controls provided by a publisher or network; and site-embedded audio controls provided for example by a network. Media players or netstreams may be associated with the different parties within this marketplace.

In an exemplary arrangement, an advertiser will make an agreement with a publisher or network partner to publish media in the form of an advertisement a fixed number of times. To fulfill this agreement the publisher or network partner will arrange for distribution of the media from an advertising server 30. The publisher or network partner will seek to publish the advertisement to a number of user terminals, in order to fulfill the agreement. If the original publisher or network partner is unable to fulfill the agreement themselves, for whatever reason, the publisher or network partner may arrange for the further distribution of the media with a second publisher or network partner in order to fulfill the original agreement,

This may then continue with the second publisher or network partner arranging for further distribution by a third publisher or network partner if the second publisher or network partner is unable to fulfill their arrangement, and so on, In the present application use of the terms “publisher” or “network partner” encompasses any or all of the publishers or network partners in this and similar scenarios.

The advertising server 30 may be a server, such as a web server, that operates to store media such as advertisements, Such media may be delivered to the user terminal 14 when a user visits a particular web page or website, In addition, advertising servers 30 may also act to target particular media to particular users depending upon a set of rules. Therefore, a specific media, such as a particular advertisement, may have been placed on a plurality of different advertising servers. However, each instance of the specific media being published to a particular user terminal 14 will have originated in a single one of the advertising servers, being supplied through one or more servers of one or more publishers or network partners such as network partner server 32 forming a chain between the source advertising server 30 and the user terminal 14, Each advertisement receives media from a publisher when a web page is loaded. In the present application use of the term “advertiser” encompasses any or all of these scenarios.

FIG. 2 illustrates schematically a diagram 40 of data acquisition from web media in accordance with an embodiment of the invention. FIG. 2 shows a representative schematic diagram of data acquisition from web media within the network shown in FIG. 1, FIG. 2 can be considered to show an advertisement call process, The publisher operates a web page or website which is accessed by the user terminal or device 14 within the web browser. To access the media on the publisher's web site the user terminal 14 utilises a media player 16, here referred to as the user media player or terminal media player 16. To play digital video and/or audio media, such as the advertisement, the terminal media player 16 of the user terminal 14 sends a call, shown as arrow 42, to a network partner media player 44 of the network partner server 32, and the network partner server 32 in turn sends a call, shown as arrow 46, to an advertiser media player 48 of the publisher media server 30 in order to play the media from the advertising server 30 through the user terminal 10. In some examples one or more of the media players may be, or comprise, netstreams. As shown in FIG. 1, there may be further network partner servers 32 of a further network partner between the publisher media or ad server 30 and the user terminal 14. In some embodiments there may be a greater number of network partners 32, In other embodiments, there may be no network partners 32. In an embodiment, the metrics media server 20 receives a request, which may be an on-line request, as a first call or ad request or unit, serves the creative and, upon playing the ad or media, triggers a second call to count the media or ad impression, which may be referred to as a media start or ad start. The media start or ad start occurs at the point in time when the first frame of media loads and is physically rendered into the destination platform. Some media may he auto play, user-initiated, click to play, cost per click, cost per engagement, and the like campaigns are identified as engagements or interactions at some creative-embedded messaging point and may be reported separately, or identified in the event data formats or signals. In other embodiments, the media or ad start is signalled by the publisher media server 30 and tracked via a metric pixel using pixel based tracking technology, as positioned by the publishers, and is therefore labelled as a publisher originating media or ad start. The source id identifies where the media start or ad start was initiated by the metrics media server 20, publisher media server 30, or the like.

FIG. 3 illustrates schematically a diagram 50 of a user device in accordance with an embodiment of the invention. The user terminal or user device 14 provides a source of metrics 52 for the system. The user device 14 may comprise a display 54 and a browser 56 for displaying a web page 58 and running a user device media player 16 to play media such as audio, video, advertisements 60, and the like.

FIG. 4 illustrates schematically a block diagram 70 of a metrics data manager and analyzer in accordance with an embodiment of the invention. Metrics data manager and analyzer 72 comprise an ingestion module 74, a metrics data manager 80, and metrics data analyzer 90. The metrics data manager 80 comprises an event repository 82, a session build module 84, and a transitory session parameter or rules module 86. The metrics data analyzer 90 comprises a session metric storage 92, a metrics processor 94, and a metrics report generator 96.

FIG. 5 illustrates schematically a block diagram 100 of event data flow from a plurality of metrics media servers to an ingestion module 74 of a metrics data manager 80 in accordance with an embodiment of the invention. FIG. 1 shows one metrics media server 20, however, the network in accordance with an embodiment of the invention may comprise one or more, forming a plurality of metrics media servers 20a,20b,20n. In practice, each metric media server 20a,20b,20n is in communication with the ingestion module 74 via a node or tracker 102a,102b,102n. The network may comprise one or more, forming a plurality of, nodes 102a,102b,102n. The metric media servers 20a,20b,20n typically look for the closest node 102a,102b,102n, however, the metric media servers may send event data in the same session or different sessions to different nodes, as shown by metrics media server 20b via node 102b and node 102n in FIG. 5.

FIG. 6 illustrates schematically a signal or data format 120 for event data in accordance with an embodiment of the invention. The data format 120 is a data chunk that is a binary string that is meaningful to the processor. The data format comprises a header with source id 122, session id 124, The data format comprises additional information shown as format 126. The source id 122 or ad player plug in identifies the source of the event data, such as user device 14. The session id 124 identifies the ad session or media session. The combination of the source-identifier (source id) and the session identifier (session id) uniquely identifies the event data. The additional information in format 126 may comprise information such as data length, timestamp, error correction code (ECC) such as cyclic redundancy check (CRC) or the like, additional data that may be used in the metric analysis. Each component of the signal or data format 120 may have a variable length or a fixed length. For example, the source id 122 and the session id 124 may have a fixed length of 3 digits and session id 124 of 20 characters. The format 126 of the remaining components may comprise a datalength of 5 digits, a timestamp of 10 digits, crc32 of 8 characters, datalength of data may have a variable length.

In an embodiment, to minimise undercounting due to caching, a random number string may be generated through a JavaScript function or server-side processes and incorporated into the delivery and measurement tags. HTTP header controls (expiry, pragma and cache-control headers) may also be used in the server response to the delivery and measurement tags.

In an embodiment, the media or ad start event is media or creative embedded and comes from a media or creative integrated media player or a display format media or ad that is controlled and served by the metrics media server 20. Accordingly, in this embodiment the media or ad start is not subject to delivery chain counting limitations/concerns typically associated with impression counting such as user abandonment, page load failures, page load latency, and the like. At first call, for example the start of the media or ad start for metrics media server 20 and publisher media server 30 originating calls, the following information or identifiers relating to a campaign which may run across multiple publisher's websites may be collected: session data and identifier and/or identification (ID); Internet protocol (IP) addresses, placement/creative/media identifiers; media or ad boot state, item numbers, time stamp; and the like. This is done continuously in real time.

FIG. 7 illustrates schematically a block diagram 140 of a metrics data manager 80 or events data holding tank in accordance with an embodiment of the invention. The metrics data manager 80 may comprise a processor 142, an event repository, a session build module 84, and a transitory session parameter module 86. The event repository may comprise a storage area for storing different status of sessions of event data. For example, the different sessions may be stored as “current” build sessions 144, “expired” sessions 146, and “confirmed” sessions 148. The event data or signals enter the event repository in a time-order basis, Event data is grouped by a key or identifiers such as in this embodiment by source ID and session ID. It will be appreciated that the event data may be grouped with other key, or in addition to the source ID and session ID. As the key is available on every event data or signal, the event data may be used to distribute load across multiple event repositories or holding tanks. The combination of the source-identifier (source ID) and the session-identifier (session ID) uniquely identifies a session globally. The session is considered finished after expiration as defined by a predetermined event, rules or parameters, such as for example after some amount of time has passed without seeing another hit, the session has grown above a certain size, or the like. Such status of the session is changes from a current status to an expired status. Expired sessions are dispatched to a processor, such as the processor 142, or any other processor 94 such as shown in FIG. 4 and FIG. 8, which may process the sessions continuously. The processor confirms the expired session causing the expired session to be flushed from memory, or if by a predetermined period of time, the expired session will be rescheduled against another processor.

FIG. 8 illustrates schematically a block diagram 160 of a metrics data analyzer 90 in accordance with an embodiment of the invention. The metrics data analyzer may comprise a processor 94, a metrics report generator 96, and a sessions metrics storage 92, The sessions metrics storage may comprise expired sessions 162 and confirmed sessions 164. In an embodiment, metrics reports may be prepared based on time ranges specifying the time zone of the associated campaign as identified in the campaign onboarding process, such as: day, 00:00:00-23:59.59 inclusive, of the day being viewed; week, 00:00:00 Monday—23:59.59 Sunday inclusive, for the week being viewed; month, 00:00:00 on day 1 of the month—23:49:49 inclusive, of the last day of the month being viewed; and the like. The detail of the report may be prepared in different degrees of granularity, for example, by the minute granularity.

FIG. 9 is a flow chart 200 of a method in accordance with an embodiment of the invention. The metrics data manager and analyzer 72 receives raw event data 202 at the ingestion module 74 from a source such as user device 14 via a string of media servers, such as metrics media server 20, publisher media server 30, and network publisher 32. The raw event data is processed in source and session format 204 such that the raw event data is formatted with a header with source id and session id, followed by other information. The event data is populated per current session 206 with event data having a common source id and session id until a predetermined event is identified marking the session either expired or confirmed 208. Once the session is expired or confirmed, the session of populated event data is transmitted 210 and flushed or removed 212 from the event repository 82, For example, the expired and confirmed sessions are transmitted 210 to the metrics data analyzer and stored, such as in the session metrics storage 92 of the metrics data analyzer 90 for metric analysis.

FIG. 10 is a state diagram 240 that shows the change or transfer of status of sessions in accordance with an embodiment of the invention. The first state of a session is the current session status 242 which is changed to another state upon identifying a predetermined event to mark the current session expired or confirmed. There are different parameters or rules for different predetermined events. For example, the predetermined event parameters may include: the maximum amount of time to wait for more signals (session_timeout); target number of sessions to keep in memory (target_sessions); maximum age of session (pension_time); time to wait for processors to confirm (reschedule_timeout); maximum number of times to retry (maximum_unconfirmed_times ; and the like. It will be appreciated that the parameters are tunable, operational, however are not functional. For example, the state is changed from current session state to an expired session state if specific parameters are met, such as pensioning 244, timeout 246, or the like. FIG. 10 shows how sessions move from the “current” set into the “expired” set by either being pensioned-off (having an age of start time larger than the pension_time, parameter), or by timing out (having an age of the last time larger than the session_timeout). As soon as the status changes from current session to expired session 248, the expired session is dispatched to processors 94 in metrics data analyzer 90, which then confirms the session to change the status to a confirmed session upon dispatch or transmission 248.

FIG. 11 is a flow chart 300 of updating session status according to time in accordance with an embodiment of the invention. A counter or “tick” is set to 0 302. Then, the system waits for an incoming signal 304. Upon receiving 306 a formatted signal or event data with source id and session id header, the signal is saved 308 as a current session in memory if it is the same source id and session id. If the signal time is not the same as the tick, and the tick is equal to zero 310, the signal is saved 308 as a current session in memory. If the tick is not equal to zero 310 and the tick is greater khan parameter state change is driven according to time 312 and the tick is incremented 314. If a session is repeatedly left in the expired state after being dispatched to the processors, the try_maximum_unconfirmed_times parameter is tried before ending the session with a terminal state status for system administrator intervention.

It will be appreciated that the method and apparatus described in the above embodiments are implemented for a media server, recordation and reporting system that functionally translates signals from a media player into some volume of the signal These principles may be implemented and applied for providing metrics on all types of media content such as advertisements, adverts, games, simulation applications, augmented and/or virtual reality applications, tutorials, online tours, educational material, entertainment applications and the like.

The methods and apparatus described may be implemented at least in part in software. Those skilled in the art will appreciate that the apparatus described may be implemented using general purpose computers or using bespoke equipment. Those skilled in the art will appreciate that the foregoing has described what is considered to be the best mode and, where appropriate, other modes of performing the invention, the invention should not be limited to the specific configurations and methods disclosed in this description of an embodiment of the invention. Those skilled in the art will recognise that the invention has a broad range of applications, and that the embodiments may take a wide range of modifications without departing from the inventive concept as defined by the appended claims.

The hardware elements, operating systems and programming languages of such computers are conventional in nature, and it is presumed that those skilled in the art. are adequately familiar therewith. Of course, the server functions may be implemented in a distributed fashion on a number of similar platforms, to distribute the processing load. Hence, aspects of the methods and apparatus described herein can be executed on a mobile station and on a computing device such as a server. Program aspects of the technology may be thought of as “products” or “articles of manufacture” typically in the form of executable code and/or associated data that is carried on or embodied in a type of machine readable medium. “Storage” type media include any or all of the memory of the mobile stations, computers, processors or the like, or associated modules hereof, such as various semiconductor memories, tape drives, disk drives and the like, which may provide storage at any time for the software programming. All or potions of the software may at times be communicated through the Internet or various other telecommunication networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software, As used herein, unless restricted to tangible non-transitory “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the data aggregator, the customer communication systems, etc. shown in the drawings, Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD OR DVD-ROM, any other optical medium, punch cards paper tape, another physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A metrics data management apparatus comprising:
an ingestion module to receive event data of a series of events from a source,
and to process the event data into a format identifying the source and a session of each event; and
an event repository to populate the event data relevant to a series of connected events of a session.

2. The metrics data management apparatus of claim 1 wherein the ingestion module receives event data from a plurality of sources.

3. The metrics data management apparatus of claim 1 wherein the session starts at the moment a request is received at the source to access a digital media.

4. The metrics data management apparatus of claim 1 wherein the ingestion module to process the event data into a format identifying the time order of each event data within a session.

5. The metrics data management apparatus of claim 1 wherein the ingestion module to process the event data into a format identifying the time order of each session.

6. The metrics data management apparatus of claim 1 wherein the ingestion module to process the event data into a format comprising a time stamp.

7. The metrics data management apparatus of claim 1 wherein the ingestion module to process the event data into a format comprising an error correction code (ECC).

8. The metrics data management apparatus of claim 1 wherein the ingestion module to process the event data into a format comprising a data length.

9. The metrics data management apparatus of claim 1 wherein the source is a user device.

10. A metrics data management apparatus comprising:
an event repository to populate event data relevant to a series of connected events of a session, wherein the event data is of a series of events from a source in a format identifying the source and a session of each event; and
a session build module to determine a complete session from event data relevant to a series of connected events of a single session by a predetermined event.

11. The metrics data management apparatus of claim 10 wherein the session ends at a predetermined event.

12. The metrics data management apparatus of claim 11 wherein the predetermined event is a period of time.

13. The metrics data management apparatus of claim 11 wherein the predetermined event is defined by predefined parameters.

14. The metrics data management apparatus of claim 1 wherein the session has a current status before the predetermined event and an expired status after the predetermined event.

15. The metrics data management apparatus of claim 14 wherein the session build module is arranged to transmit the session with an expired status for further processing at a metrics data analyzer processor and the session has a confirmed status after the transmission and further processing of the expired session.

16. The metrics data management apparatus of claim 15 wherein the session build module is arranged to remove the expired status session and confirmed status sessions from the session build module and corresponding event data from the event repository after transmission and further processing of the expired session.

17. A metrics data management apparatus comprising:
an ingestion module to receive event data of a series of events from a source,
and to process the event data into a format identifying the source and a session of each event;
an event repository to populate the event data relevant to a series of connected events of a session; and
a session build module to determine a complete session from event data relevant to a series of connected events of a session by a predetermined event.

18. A metrics data management apparatus of claim 17 further comprising a metrics data analyzer comprising a metrics report generator for generating a report based on the complete session.

19. A metrics data management method of comprising:
receiving event data of a series of events from a source;
processing the event data into a format identifying the source and a session of each event;
populating the event data relevant to a series of connected events of a session into an event repository; and
determining a complete session from event data relevant to a series of connected events of a single session by a predetermined event.

20. A metrics data management method of claim 17 further comprising generating a report based on the complete session.
